(19) United States
(12) Patent Application Publication
(10) Pub. No.: US 2018/0274629 A1
(43) Pub. Date: Sep. 27, 2018

(54) PULLING ROPE TYPE FAST RELEASING STURCTURE

(71) Applicants: MAW-LEI LEE, TAIPEI CITY (TW); SHU-LUU WANG, NEW TAIPEI CITY (TW)

(72) Inventors: MAW-LEI LEE, TAIPEI CITY (TW); SHU-LUU WANG, NEW TAIPEI CITY (TW)

(21) Appl. No.: 15/469,485

(22) Filed: Mar. 24, 2017

(51) Int. Cl. F16G 11/00; F16B 1/00; F16B 2/08

(52) U.S. Cl. CPC F16G 11/00; F16B 2001/0028; F16B 2/08; F16B 1/00

(57) ABSTRACT

A pulling rope type fast releasing structure, comprising: a leg fastening strap, being a short strap, and having both ends provided with a Velcro strap, to circle to form into a ring body; a fastening seat, disposed on the leg fastening strap; a fast connector, with its one end disposed in the fastening seat; and a pulling rope, connected to one other end of the fast connector. Wherein, the fast connector is provided with a pressing piece and a sleeve connection piece being assembled and detachable to each other; a ring of fastening slot is disposed in a connection port in front of the sleeve connection piece; a plurality of steel beads and bead holes are disposed on the pressing piece, and being movably fastened to the sleeve connection piece; and at least an elastic press key, disposed on the pressing piece.

### BACKGROUND OF THE INVENTION

### Field of the Invention

The present invention relates to a pulling rope type fast releasing structure, and in particular to a pulling rope type fast releasing structure, in which a fast connector is disposed between a leg fastening strap and a pulling rope for capable of being detaching quickly, to enhance the safety of a surfer while surfing.

### The Prior Arts

Surfing is an interesting and exciting water sport, it is very popular among and cherished by the sports loving people. While surfing, pulling ropes and leg fastening straps are used to tie the surfer's feet onto the surfboard to ensure safe surfing. In case a surfer falls into water, through using the pulling ropes and the leg fastening straps, the surfboard can be pulled to the side of the surfer, for the surfer to lean on to keep afloat, while preventing the surfboard from floating away.

The conventional leg fastening strap is a short strap having both ends provided with a Velcro tape (stick-snap tape). In application, the Velcro tape is snapped into a circle to form a ring body. A rotation connector is disposed between the leg fastening strap and the pulling rope to prevent intertwining of the two items. However, for the connection parts at both ends of the rotation connector connecting to the pulling rope and the leg fastening strap respectively, bolts and rivets are used to achieve fixing, so that the pulling rope and the leg fastening strap must be purchased together as a single unit.

The major disadvantage of the conventional leg fastening strap is that, in an emergency of a surfer falling into water, the leg fastening strap can not be detached from the connection parts quickly, so that it has to be torn open from the location of the Velcro tape. Such a detaching process is difficult and time consuming, so some of the surfers may not be able to react in time to achieve detaching. As such, when big wave comes, the surfboard tied to the surfer's foot through a rope (of 2 to 3 meters) could be pushed by the big waves toward the surfer, to hit and hurt the surfer badly. Moreover, the towering big waves coming down from above could bring the rope down into the sea to be hooked by the sea reef, thus entangling and drawing the surfer into the sea to be drowned.

Therefore, presently, the design and performance of the pulling rope type releasing structure is not quite satisfactory, and it leaves much room for improvement.

### SUMMARY OF THE INVENTION

In view of the problems and drawbacks of the prior art, the present invention provides a pulling rope type fast releasing structure, comprising a leg fastening strap, a fastening seat, a fast connector, and a pulling rope. The leg fastening strap is a short strap, having both ends provided with a Velcro strap, to circle and form into a ring body. The fastening seat is disposed on the leg fastening strap. The fast connector is adapted to have its one end disposed in the fastening seat. And the pulling rope is connected to one other end of the fast connector. Further, the fast connector is provided with a pressing piece and a sleeve connection piece, and that can be assembled and detached from each other. A ring of fastening slot is disposed in a connection port in front of the sleeve connection piece. A plurality of steel beads and bead holes are disposed on the pressing piece, and are movably fastened to the sleeve connection piece. At least an elastic press key is disposed on the pressing piece, and is connected to the release push pin to move, to control the plurality of steel beads to retract inward to be released. As such, the pulling rope and the leg fastening strap can be detachable quickly, to enhance safety of a surfer while surfing.

Compared with the conventional technology, in the present invention, a fast connector is provided between the pulling rope and the leg fastening strap, while the pressing piece and sleeve connection piece can be assembled and detached easily, so that the leg fastening strap and the pulling rope of various sizes can be packaged and sold separately, to provide more selections for the customers while saving their expenses.

Further, when a surfer falls into water while surfing, he can press the elastic press key on the pressing piece, to connect it to the release push pin disposed inside to move, for controlling the plurality of steel beads to retract inward, so that the fastening slot of the sleeve connection piece can be detached and released easily, to cause quick detaching of the pulling rope from the leg fastening strap, thus enhancing safety of the surfer effectively while surfing.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from the detailed descriptions.

### BRIEF DESCRIPTION OF THE DRAWINGS

The related drawings in connection with the detailed descriptions of the present invention to be made later are described briefly as follows, in which:

FIG. 1 is an exploded view of a pulling rope type fast releasing structure according to an embodiment of the present invention;

FIG. 2 is a perspective view of a fast connector according to an embodiment of the present invention;

FIG. 3 is a cross section view of an assembled pulling rope type fast releasing structure according to an embodiment of the present invention;

FIG. 4 is a schematic diagram of a pulling rope type fast releasing structure in operation according to an embodiment of the present invention; and

FIG. 5 is a cross section view of an assembled pulling rope type fast releasing structure according to another embodiment of the present invention.

### DETAILED DESCRIPTION OF THE PREFERRED EMBODIMENT

The purpose, construction, features, functions and advantages of the present invention can be appreciated and understood more thoroughly through the following detailed descriptions with reference to the attached drawings.

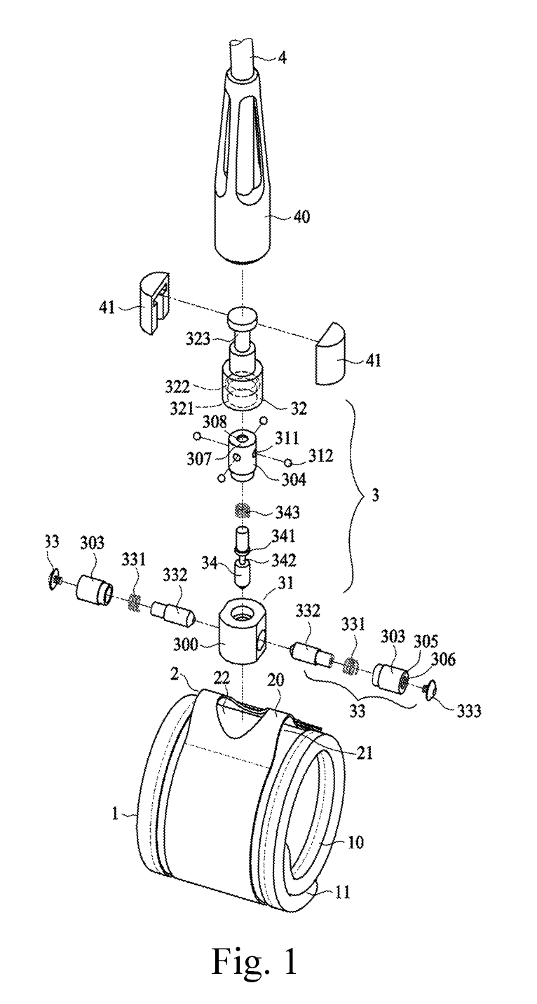

Refer to FIGS. 1 to 4 respectively for an exploded view of a pulling rope type fast releasing structure according to an embodiment of the present invention; a perspective view of a fast connector according to an embodiment of the present invention; a cross section view of an assembled pulling rope type fast releasing structure according to an embodiment of the present invention; and a schematic diagram of a pulling rope type fast releasing structure in operation according to an embodiment of the present invention.

As shown in FIGS. 1 to 4, the present invention provides a pulling rope type fast releasing structure, comprising: a leg fastening strap 1, a fastening seat 2, a fast connector 3, and a pulling rope 4. The leg fastening strap 1 is a short strap, having both ends provided with a Velcro strap 11, to circle and form into a ring body 10. The fastening seat 2 is disposed on the leg fastening strap 1. The fast connector 3 is adapted to have its one end disposed in the fastening seat 2. And the pulling rope 4 is connected to one other end of the fast connector 3. Further, the fast connector 3 is provided with a pressing piece 31 and a sleeve connection piece 32, and that can be assembled and detached from each other. A ring of fastening slot 322 is disposed in a connection port 321 in front of the sleeve connection piece 32. A plurality of steel beads 312 and bead holes 311 are disposed on the pressing piece 31, and are movably fastened to the sleeve connection piece 32. At least an elastic press key 33 is disposed on the pressing piece 31, and is connected to the release push pin 34 to move, to control the plurality of steel beads 312 to retract inward to be released. As such, the pulling rope 4 and the leg fastening strap 1 can be detachable quickly, to enhance safety of a surfer while surfing.

The pressing piece 31 is disposed on the fastening seat 2 of the leg fastening strap 1, while the sleeve connection piece 32 is disposed at one end of the pulling rope 4. The fastening seat 2 is formed by a curling connection plate 20 having two side holes 21 and an upper hole 22 to match and receive the pressing piece 31.

A tail end of the sleeve connection piece 32 is formed into an I-shape portion 323 having the shrinking radius, for wrapping by two half inner sleeves 41, while a seal shell 40 is fixed around outside. As such, the assembled sleeve connection piece 32 is able to rotate between the two half inner sleeves 41, to prevent the intertwining of the pulling rope 4.

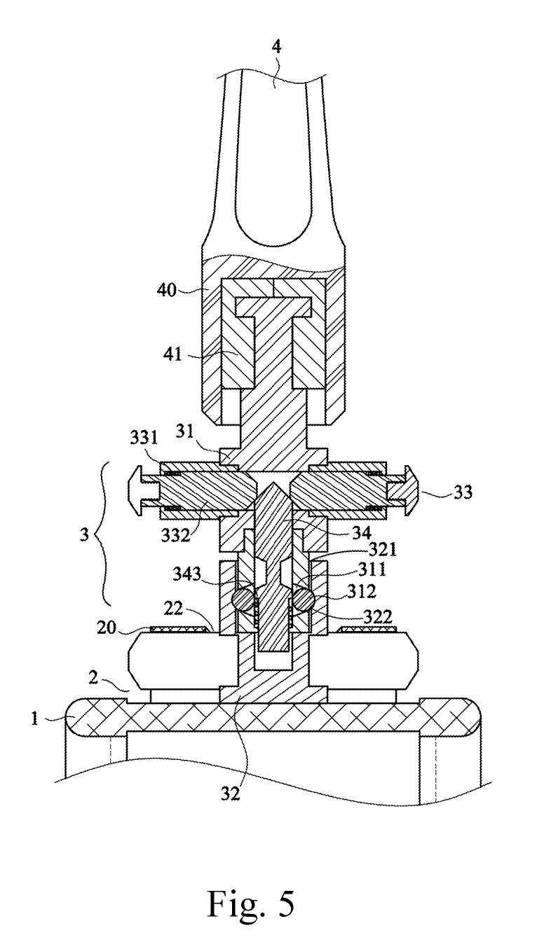

Refer to FIG. 5 for a cross section view of an assembled pulling rope type fast releasing structure according to another embodiment of the present invention. As shown in FIG. 5, the pressing piece 31 is disposed at one end of the pulling rope 4, the sleeve connection piece 32 is disposed on the fastening seat 2 of the leg fastening strap 1, while the fastening seat 2 is formed by a curling connection plate 20 having at least the upper hole 22 to match and receive the sleeve connection piece 32.

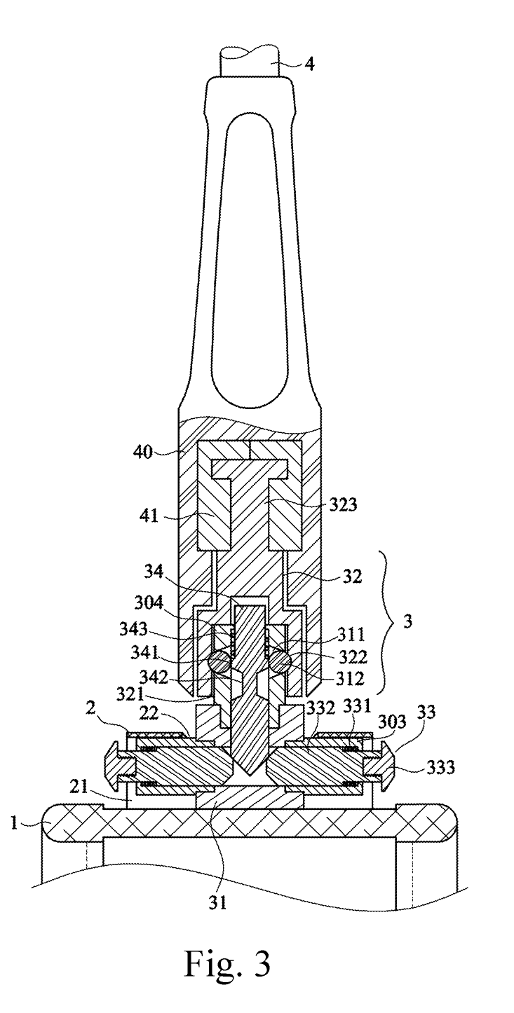

As shown in FIG. 3, a fast connector 3 is provided between the pulling rope 4 and the leg fastening strap 1, while the pressing piece 31 and sleeve connection piece 32 can be assembled and detached easily, so that the leg fastening strap 1 and the pulling rope 4 of various sizes can be packaged and sold separately, to provide more selections for the customers while saving their expenses.

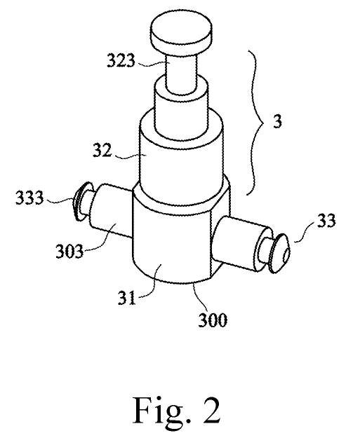

As shown in FIGS. 2 to 4, when a surfer falls into water while surfing, he can press the elastic press key 33 on the pressing piece 31, to connect it to the release push pin 34 disposed inside to move, for controlling the plurality of steel beads 312 to retract inward, so that the fastening slot 322 of the sleeve connection piece 32 can be detached and released easily, to detach the pulling rope 4 from the leg fastening strap 1 quickly, to enhance safety of the surfer effectively while surfing.

As shown in FIGS. 1 and 3, the pressing piece 31 is provided with a T-shape 3-way main body 300, and having two side tubes 303 and a straight tube 304, the side tube 303 having a seal plate 305 provided at its tail end, and having a through hole 306 provided on the seal plate 305; while the straight tube 304 having seal plate 307 provided at its tail end, and having a through hole 308 provided on the seal plate 307. The two elastic press keys 33 are each provided on the left and the right of the pressing piece 31, while a press spring 331 and a push pin 332 are provided respectively in each side tube 303. The press portion 333 is disposed at a rear end of the push pin 332, and penetrating through a through hole 306 in the seal plate 305 of the side tube 303.

A plurality of bead holes 311 of a cone-shape are disposed around a wall of the straight tube 304, for the plurality of steel beads 312 to fill outward to restrict positions. A release push pin 34 is provided in the straight tube 304, while the through hole 308 is provided penetrating through the seal plate 307 of the straight tube 304, a sharp end is provided at a lower portion of the release push pin 34, opposite the sharp ends of the two push pins 332. And a round press squeeze portion 341 and an indent release portion 342 are provided on a side of the release push pin 34, for allowing the plurality of steel beads 312 to protrude outward or retract inward.

The three-way main body 300 is formed by a central hole block, the two side tubes 303, and the straight tube 304; while the press spring 343 is provided between the release push pin 34 and the seal plate 307 of the straight tube 304. The four bead holes 311 are provided around a side wall of the straight tube 304, to receive the four corresponding steel beads 312; while the indent release portion 342 of the release push pin 34 is formed by an indent slot of a shrinking radius.

In application, as shown in FIGS. 1 and 3, when the pressing piece 31 of the fast connector 3 is assembled to the sleeve connection piece 32, the round press squeeze portion 341 of the release push pin 34 remains at its normal position, to press against an inner side of the bead hole 311. As such, the steel beads 312 are made to protrude outward to fasten into the fastening slot 322 in the connection port 321 of the sleeve connection piece 32. Therefore, the sleeve connection piece 32 and the pressing piece 31 are in a locked state, while the pulling rope 4 and the leg fastening strap 1 are connected securely together through the fast connector 3.

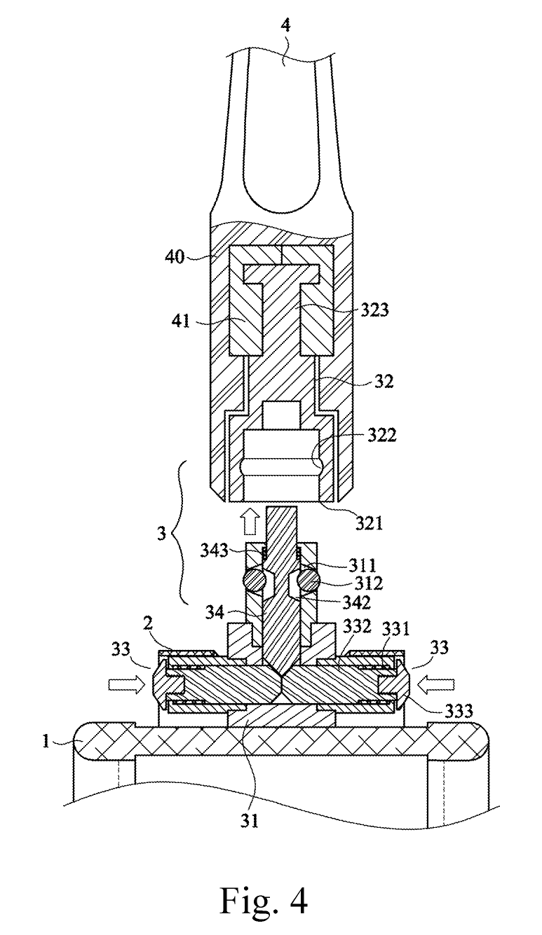

Finally, as shown in FIGS. 1 and 4, when a surfer falls into water, he does not have to tear open the leg fastening strap 1 from the Velcro tape 11 as in the past. All the surfer has to do is to press timely the elastic press key 33 on both sides of the pressing piece 31, to make the two push pins 332 inside to retract inward, with their sharp ends touching and pushing that of the release push pin 34 upward, so that the indent release portion 342 moves to the inner side of the bead hole 311. As such, the plurality of steel beads 312 move to retract inward, so they are detached and released from the fastening slot 322 of the sleeve connection piece 32, thus making the pulling rope 4 to detach from the leg fastening strap 1 quickly, to enhance the safety of the surfer effectively while surfing. In this approach, it could avoid the danger of the surfboard being pushed by the big waves to hit and hurt the surfer falling into water, or the pulling rope being brought down by the towering big waves into the sea to be hooked by the sea reef, thus entangling and drawing the surfer into the sea to be drowned.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A pulling rope type fast releasing structure, comprising:
a leg fastening strap, being a short strap, and having both ends provided with a Velcro strap, to circle to form into a ring body;
a fastening seat, disposed on the leg fastening strap;
a fast connector, with its one end disposed in the fastening seat; and
a pulling rope, connected to one other end of the fast connector;
wherein,
the fast connector is provided with a pressing piece and a sleeve connection piece being assembled and detachable to each other;
a ring of fastening slot is disposed in a connection port in front of the sleeve connection piece;
a plurality of steel beads and bead holes are disposed on the pressing piece, and are movably fastened to the sleeve connection piece;
at least an elastic press key is disposed on the pressing piece, and is connected to the release push pin to move, to control the plurality of steel beads to retract inward to be released;
as such, the pulling rope and the leg fastening strap are detachable quickly, to enhance safety of a surfer while surfing.

2. The pulling rope type fast releasing structure as claimed in claim 1, wherein the pressing piece is provided with a T-shape 3-way main body, having
two side tubes and a straight tube, the side tube having a seal plate provided at its tail end, and having a through hole provided on the seal plate, while the straight tube having seal plate provided at its tail end, and having a through hole 308 provided on the seal plate;
the two elastic press keys are each provided on the left and the right of the pressing piece, while a press spring and a push pin are provided respectively in each side tube;
a press portion is disposed at a rear end of the push pin, and penetrating through a through hole in the seal plate of the side tube;
a plurality of bead holes of a cone shape are disposed around a wall of the straight tube, for the plurality of steel beads to fill outward to restrict positions;
a release push pin is provided in the straight tube, while the through hole is provided penetrating through the seal plate of the straight tube, a sharp end is provided at a lower portion of the release push pin, opposite the sharp ends of the two push pins; and
a round press squeeze portion and an indent release portion are provided on a side of the release push pin, for allowing the plurality of steel beads to protrude outward or retract inward.

3. The pulling rope type fast releasing structure as claimed in claim 2, wherein the three-way main body is formed by a central hole block, the two side tubes, and the straight tube; while the press spring is provided between the release push pin and the seal plate of the straight tube.

4. The pulling rope type fast releasing structure as claimed in claim 2, wherein the four bead holes are provided around a side wall of the straight tube, to receive the four corresponding steel beads; while the indent release portion of the release push pin is formed by an indent slot of a shrinking radius.

5. The pulling rope type fast releasing structure as claimed in claim 2, wherein a tail end of the sleeve connection piece is formed into an I-shape portion having the shrinking radius, for wrapping by two half inner sleeves, while a seal shell is fixed around outside.

6. The pulling rope type fast releasing structure as claimed in claim 1, wherein the pressing piece is disposed on the fastening seat of the leg fastening strap, the sleeve connection piece is disposed at one end of the pulling rope; while the fastening seat is formed by a curling connection plate having two side holes and an upper hole to match and receive the pressing piece.

7. The pulling rope type fast releasing structure as claimed in claim 2, wherein the pressing piece is disposed on the fastening seat of the leg fastening strap, the sleeve connection piece is disposed at one end of the pulling rope; while the fastening seat is formed by a curling connection plate having two side holes and an upper hole to match and receive the pressing piece.

8. The pulling rope type fast releasing structure as claimed in claim 1, wherein the pressing piece is disposed at one end of the pulling rope, the sleeve connection piece is disposed on the fastening seat of the leg fastening strap, while the fastening seat is formed by a curling connection plate having at least the upper hole to match and receive the sleeve connection piece.

9. The pulling rope type fast releasing structure as claimed in claim 2, wherein the pressing piece is disposed at one end of the pulling rope, the sleeve connection piece is disposed on the fastening seat of the leg fastening strap, while the fastening seat is formed by a curling connection plate having at least the upper hole to match and receive the sleeve connection piece.
